(19) United States
(12) Patent Application Publication
(10) Pub. No.: US 2024/0370092 A1
(43) Pub. Date: Nov. 7, 2024

(54) SWIPE GESTURES DETECTED ON SURFACES OF AN INPUT DEVICE USING A MICROPHONE ARRAY

(71) Applicant: Sony Interactive Entertainment Inc., Tokyo (JP)

(72) Inventors: Glenn Black, San Mateo, CA (US); Jeffrey Stafford, San Mateo, CA (US)

(21) Appl. No.: 18/313,275

(22) Filed: May 5, 2023

(51) Int. Cl. G06F 3/01; G01H 17/00; G06F 1/16; G06F 3/16

(52) U.S. Cl. CPC G06F 3/017; G01H 17/00; G06F 1/1684; G06F 3/167; G06F 1/163

(57) ABSTRACT

An input device for detecting and interpreting gesture input includes an interactive input interface for receiving the gesture input from a user. A microphone is used to capture audio generated in physical environment in vicinity of the input device. The audio captured includes ambient sound of the physical environment and the signature audio sound of the gesture input. An audio filter is configured to detect different frequencies of audio captured by the microphones and to selectively filter out the ambient sound and retain the signature audio sound. The signature audio sound is interpreted to identify an input that corresponds with the gesture input. The input is provided to activate a function within an interactive application.

### BACKGROUND OF THE INVENTION

### 1. Field of the Invention

The present disclosure relates to detecting hand gestures of a user provided on a surface of an input device and interpret the hand gestures to identify an input to an interactive application.

### 2. Description of the Related Art

Users interact with various content available on the Internet and/or shared by other users using various input devices. The various inputs include text, video, audio, graphic interchange format files (GIFs), images, comments (audio and/or video), or any other type that conveys a message, a command to be performed or an instruction to followed. The input devices used to provide such inputs range from a traditional keyboard, mouse, to a touch screen, a microphone, controller, headphones, etc. The inputs provided using these input devices are used to convey messages, control devices, exchange information, inputs to interactive application, control game objects/avatars, etc.

There is always a desire to find other forms of input without incurring additional cost. It is also a desire to find other forms of inputs using existing input devices without having to do extensive re-design.

It is in this context that embodiments of the invention arise.

### SUMMARY OF THE INVENTION

Implementations of the present disclosure relate to systems and methods for detecting gesture input provided by a user on an input device and to interpret the gesture input to define a corresponding input for applying to an interactive application. The gesture input can be provided on the surface of the input device, and, in some cases, where a pattern is defined on the surface. Alternately, a physical sticker with a pattern defined thereon can be stuck to a surface of the input device. The pattern generates a distinct, low fidelity signature audio sound that can be picked up by a microphone disposed on the input device or on a second device that is proximal to the input device on which the gesture input is provided by the user. The microphone can be disposed on an inside surface or on an outside surface or embedded within the input device or the second input device. The gesture input can be a swipe gesture or a tap gesture or a soft press that generates audio sound having distinct frequency profile. The microphone captures all the audio that is generated in a vicinity of the input device or the second input device on which the microphone is disposed. An audio filter within the input device (or second input device) is used to filter out unwanted audio and retain audio having a specific frequency profile. In the case of the gesture input, the audio filter is configured to filter out sounds that do not match the specific frequency profile and retain sounds that match the certain frequency profile. The retained audio is interpreted to define an input for an interactive application that corresponds with the gesture input.

The low fidelity gesture input can be used as another form of input provided by the user, in addition to inputs provided using traditional methods on known input devices, such as controllers, keyboards, mouse, touch screen with sensors distributed thereon to detect the input, etc. The gesture input is detected by capturing audio data rather than sensor data. The captured audio is then processed to identify additional data that can be used to validate the input provided using traditional or known input methods or define new functions.

In one implementation, an input device is disclosed. The input device includes an interactive input interface for receiving input from a user. The input is a gesture input having a signature audio sound. A microphone within the input device is used to capture audio generated in vicinity of the input device including the signature audio sound provided by the input from the user. The signature audio sound is defined to have a frequency profile. An audio filter is configured to detect different frequency profiles of audio captured from the vicinity of the input device and to selectively detect and retain the signature audio sound of the input and filter out audio with frequency profiles that do not match the frequency profile. The signature audio sound with the frequency profile is interpreted to identify an additional input to an interactive application.

In another implementation, an input device is disclosed. The input device includes a physical sticker disposed on a surface. The physical sticker includes a micro-mesh that is designed to provide a signature audio sound when a finger of a user is run over the micro-mesh. A microphone is used to capture sound generated in vicinity of the input device including the signature audio sound provided at the surface of the physical sticker. The signature audio sound of the input is defined to have a frequency profile. An audio filter is configured to detect different frequency profiles of audio captured from the vicinity of the input device and to selectively detect and retain the signature audio sound having the frequency profile by filtering out audio with frequency profiles that do not match the frequency profile. The signature audio sound is interpreted to identify a gesture input provided at the micro-mesh of the physical sticker. The gesture input defines an additional input provided by the user to an interactive application.

In yet another implementation, an input device is disclosed. The input device includes a touchpad providing an input surface for receiving input from a user. One or more physical stickers are provided for placement on the input surface of the touchpad. Each physical sticker has a micro-mesh that defines a pattern that is designed to provide a signature audio sound when a finger of a user is run over surface of the physical sticker. A microphone array is disposed on the touchpad. The microphone array includes a plurality of microphones. Each microphone in the microphone array is configured to detect and capture audio generated in the vicinity of the input device. The audio captured includes the signature audio sound generated by the finger of the user running over surface of each physical sticker disposed on the touchpad. The signature audio sound generated by each physical sticker is interpreted to identify a distinct function of an interactive application. A power source is provided to supply power to the microphone array and to other electronic parts disposed in the touchpad. A wireless communication connection is provided to allow communication between the touchpad and a computing system executing the interactive application. The wireless communication connection is used to communicate a signal to activate the distinct function associated with the physical sticker at the interactive application, upon detecting the finger of the user running over the surface of the physical sticker.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

FIG. 1 represents a simplified block diagram of a system that identifies a plurality of wearable devices and input devices available to a user for providing input, including gesture input to an interactive application, in accordance with one implementation.

FIG. 2 illustrates a simplified block diagram of an audio filter module used to detect and interpret the gesture inputs of the user provided on the surface of the input device, in accordance with one implementation.

FIG. 2A illustrates a simplified block diagram of a function detection engine of the audio filter module of FIG. 2 used to pinpoint the location of the source of the signature audio sound provided on a surface of the input device, in accordance with an alternate implementation.

FIGS. 3A and 3B illustrate examples of beamforming used to pinpoint the location of the source of the signature audio sound provided on a physical sticker disposed on a surface of the input device, in accordance with some implementations.

FIGS. 4A-4E illustrate some examples of input devices on which microphone arrays are disposed to detect gesture inputs provided on a surface of the input devices, in accordance with some implementations.

FIGS. 5A-5E illustrate some examples of input devices on which physical stickers with micro-mesh are disposed on surface of the input devices to provide a patterned surface for providing gesture inputs and microphone arrays disposed within to detect the gesture inputs provided on the surface of the input devices, in accordance with some implementations.

FIGS. 6A-6B illustrate some examples of interactive touchpad on which physical stickers with micro-mesh are disposed on surface to provide a patterned surface for providing gesture inputs and microphone arrays disposed within to detect the gesture inputs provided on the surface of the input devices, in accordance with some implementations.

FIG. 7 illustrates flow of operations of a method for detecting gesture input provided on a surface of an interactive input device and for interpreting the gesture input to identify additional input for an interactive application, in accordance with one implementation.

FIG. 8 illustrates components of an example device and/or platform system that can be used to perform aspects of the various embodiments of the present disclosure.

### DETAILED DESCRIPTION

Systems and method for detecting additional gesture input provided on a surface of an input device and interpreting the gesture input to provide additional input to an interactive application are described. It should be noted that various implementations of the present disclosure are practiced without some or all of the specific details. In other instances, well known process operations have not been described in detail in order not to unnecessarily obscure various embodiments of the present disclosure.

The various implementations described herein allow an audio filter module within an input device to detect and selectively use signature audio sound generated from a finger gesture on an input device as additional input for an interactive application. The finger gesture can be on a portion of a surface of the input device, wherein the finger gesture can be a forward swipe, a backward swipe, an upward swipe, a downward swipe, a soft touch, a single tap, multiple taps, etc. Each of the finger gesture generates a signature audio sound that can be detected and processed by an audio filter disposed within the input device to identify an input. The input identified from the finger gesture can correspond with an input button of the input device (e.g., control button of a controller) that corresponds with a pre-defined input action/function. Alternately, the input identified from the finger gesture can be used to define additional input action/function. The input identified from the finger gesture on the surface of the input device can be applied to an interactive application executing on a computing device that is communicatively connected to the input device. The computing device can be a local computer (e.g., a game console) or a remote computer (e.g., remote server) accessible over a network, such as the Internet, on which the interactive application is executing. The input device can be a keyboard, a controller, a touchpad, a headset (e.g., a headphone, such as a noise-cancelling headphone, carphone, etc., or a head mounted display (HMD), or the like), a wearable device, such as a glove interface object, or the like.

In some cases, the portion on the input device where the finger gesture is provided includes a physical pattern that causes a signature audio sound when the finger of the user is run over the pattern. The pattern can be from an icon or logo or self-design defined on the surface of the input device. In some cases, the physical pattern can include indentations that are deep enough so that the signature audio sound generated when the finger is run over the physical pattern is easily detected. In some cases, depending on the orientation and/or location of the physical pattern on the surface of the input device, different signature audio sounds can be generated by running the finger(s) differently. The different signature audio sounds can be used to define different inputs for the finger gestures. For instance, when the pattern is defined with horizontally oriented indentations, an upward or downward swipe of the finger(s) of the user over the pattern can generate a signature audio sound that can be distinctly different from the signature audio sound generated for a horizontal swipe using the user's finger(s) over the same pattern.

In other cases, the portion of the input device can have a physical sticker with a pattern defined thereon. The pattern on the physical sticker is defined to generate a distinct signature audio sound. The pattern can be defined using a micro-mesh, wherein a specific design of the micro-mesh can be associated with a particular function button of an input device (e.g., a controller, keyboard), which, in turn, can correlate with an input function of an interactive application. When a user's finger runs over the pattern, the signature audio sound generated from the user's finger over the surface of the pattern is captured by the audio filter module and interpreted to identify the input function associated with the pattern. The audio filter can then generate and forward an input signal to the interactive application with instructions to the interactive application to activate the input function.

In some cases, more than one physical sticker may be provided or a physical sticker may be provided in addition to a physical pattern on the surface of an input device to define distinctly different input functions. The input function defined for each physical sticker and/or physical pattern can be an additional form of input (i.e., additional way to activate) for an existing function associated with an input control available on the input device or can define new functions that are in addition to the functions associated with the existing input controls. When more than one physical sticker is provided, each physical sticker can be defined using a micro-mesh with distinct pattern and be associated with a distinct function. The distinct pattern of each physical sticker is designed to generate a discernable signature audio sound that can be discerned by the audio filter. Alternately, each physical sticker can have the same pattern defined using the micro-mesh. In such cases, the position and/or orientation of each physical sticker can be used to define different signature audio sound. The audio filter detects the signature audio sound gencrated at the specific pattern to determine the specific pattern that was used to provide the finger gesture and to identify and activate the specific function associated with the physical sticker, for example. The function defined for each physical sticker can correspond to an existing functional button of the input device (e.g., controller or keyboard) or can be a new function. When the finger gesture input is for a new function, the finger gesture input provides an additional input for use in an interactive application executing on a computing system, for example.

The finger gestures provide alternate forms of inputs that can be used to activate a functional button on the existing input device or used to define additional function for use in an interactive application. These alternate forms provide a versatile and a low-cost solution for using an existing input device to generate alternate forms of inputs to activate existing function buttons/functions and/or to define additional function buttons/functions. The physical stickers and/or physical patterns are programmed to correspond with particular functions. In some cases, each of the physical stickers can be customized to define different functions for different interactive applications. In some cases, instead of a physical sticker on the surface of an existing input device, a touchpad can be configured with an interactive input interface to receive finger gestures of the user and use an audio filter defined within the touchpad to interpret the finger gestures of the user to identify and activate specific functions defined for the finger gestures. The surface of the touchpad can itself be a textured surface used to receive the finger gestures or can be used to receive one or more physical stickers that have distinct surface patterns to receive the finger gestures. The finger gestures on the patterned surface of the touchpad or on the physical sticker on the touchpad are interpreted to identify the corresponding functions for providing to an interactive application. The location and orientation of the physical stickers on the surface of the input device or on the touchpad can be used to customize the inputs defined from the finger gestures on such surfaces, making this a versatile solution for providing alternate forms of inputs to an interactive application. In alternate implementations, the audio filter can be on a different input device that is communicatively connected to the touchpad. In such cases, the audio filter on the second input device is configured to detect the signature audio sound generated on the touchpad by the finger gestures and to interpret the finger gestures to define an input.

With the general understanding of the disclosure, specific implementations of providing ways for the user to provide alternative or additional inputs will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

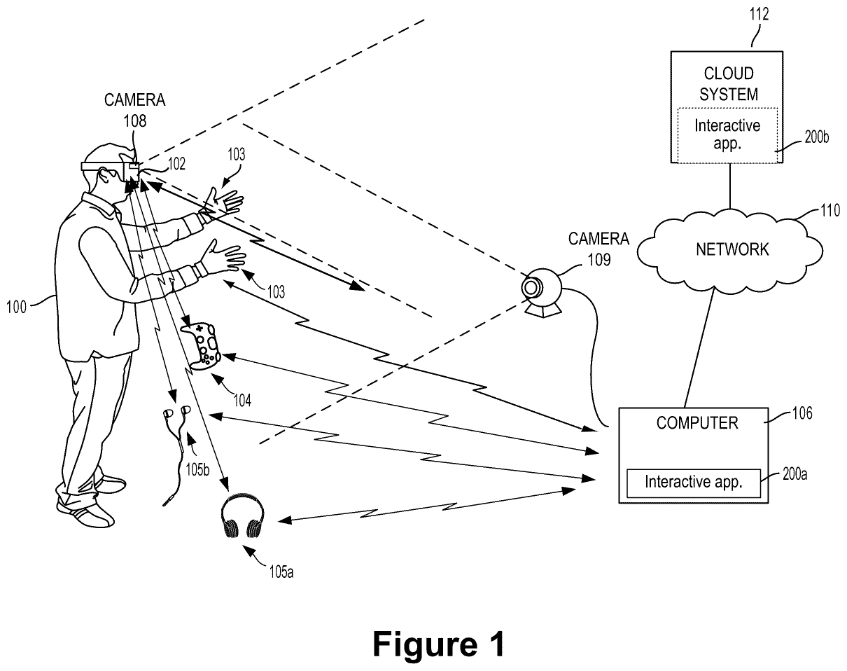

FIG. 1 illustrates a simplified block diagram of an example system in which different input devices are used by a user 100 to provide input to an interactive application executing on a computer that is located locally or remotely from the user providing the input, in some implementations. The input devices include wearable devices and hand-held or hand-operatable devices. Some of the wearable devices include a head mounted display (HMD) 102, a glove interface object 103, smart-glasses (not shown), a headphone 105a or an carphone 105b, and the like. The headphones and earphones both include speakers. The headphones are worn around a head and over the cars of the user while the earphones are inserted into the car canals of the user. The hand-held devices include controllers 104 (both single-hand-held or double-hand-held controllers), keyboards (not shown), touchpads (not shown), touchscreen (not shown), etc., with controls or buttons/keys or control surfaces for providing input. Each of the input devices (103, 104, 105a, 105b, etc.,) are communicatively connected to the HMD 102, and/or with the computer 106 and/or with the server of the cloud system 112 to enable communication between the devices to exchange content, provide inputs, and/or control actions or activities of an interactive application, wherein interaction with the remote server is through a network 110, such as the Internet. The user can use any one of the input devices to interact with an interactive application 200a executing locally on the computer 106 (e.g., video game executing on a game console), or remotely with interactive application 200b executing at the server of the cloud system 112.

In the example system shown in FIG. 1, a user 100 is shown wearing a head mounted display (HMD) 102. The HMD 102 can be worn in a manner similar to glasses, goggles, or a helmet, and is configured to allow the user to interact with the content rendered on a display screen of the HMD 102. The HMD 102 provides a very immersive experience to the user by virtue of its provision of display mechanisms in close proximity to the user's eyes. Optics provided in the HMD 102 enable the user to view the content rendered in close proximity to the user's eyes. The optics takes into consideration the visual characteristics of the user when presenting the content to the user. In an alternate implementation, in place of the HMD 102, the user 100 may be wearing a pair of smart eyeglasses (not shown), wherein the pair of smart eyeglasses allow the user to experience the real-world environment as well as augmented reality content. The HMD 102 and the pair of eyeglasses includes one or more surfaces that can be configured for receiving interactive user input.

In one embodiment, the HMD 102 is connected to a computer through a wireless communication connection although wired connection can also be envisioned. The computer may be a local computer 106 (e.g., gaming console) or a server computer (simply referred to as “server”) that is part of a cloud system 112 located remote to the HMD 102. The computer (106/or part of cloud system 112) can be any general or special purpose computer known in the art, including but not limited to, a gaming console, personal computer, laptop, tablet computer, mobile device, cellular phone, tablet, thin client, part of a set-top box, media streaming device, virtual computer, remote server computer, etc. With regards to remote server computer (i.e., part of cloud system 112), the server computer may be a cloud server within a data center of the cloud system 112. The data center can include a plurality of servers that provide the necessary resources to host one or more interactive applications 200b that can be accessed by the user over the network 110. In some implementations, the server may include a plurality of consoles and an instance of the interactive application may be accessed from one or more consoles (e.g., game consoles). The consoles may be independent consoles or may be rack-mounted server or a blade server. The blade server, in turn, may include a plurality of server blades with each blade having required circuitry and resources for instantiating a single instance of the interactive application, for example, to generate the necessary content data stream that is forwarded to the HMD 102 for rendering, for example. The content data stream can also be rendered on a display screen associated with the computer 106. Alternately, the interactive application 200a can be executing on the local computer 106.

Depending on where the interactive application (200a, 200b) is executing, the content of the interactive application (200a, 200b) is provided to the HMD 102 directly from the computer 106 or from a server of the cloud system 112 over the network 110. In the case of the server providing the content to the HMD 102, the content can be sent over the network 110 and through the computer 106, or directly over the network 110 to the HMD 102, in which case, the HMD 102 is a networked device that is independently and directly connected to the network 110. The user can interact with the content by providing inputs using one or more of the input devices. The inputs provided using the different input devices include finger gestures provided using glove interface object 103, finger gestures and/or control inputs provided using input surface and/or controls of a controller 104, inputs provided using keys or finger gestures on a keyboard and/or input surface of the computer 106, touch inputs and/or finger gestures provided using a touch screen associated with the computer 106 or the HMD 102, or audio commands/instructions provided using microphones of headphones 105a, earphones 105b, etc. Each of the input devices (103, 104, 105a, 105b, etc.) are also communicatively connected to the HMD 102 and the computer 106 to enable the input from the input devices to be communicated to the interactive application 200a (executing on local computer 106) or 200b (executing on a server at the cloud system 112). In some implementations, in addition to the HMD 102, the glove interface object 103, controller 104, headphones 105a, earphones 105b, etc., may each be a networked device that independently and directly connects to the network 110 to communicate the inputs provided at the respective input devices to the computer 106 or the server that is part of the cloud system 112.

In addition to the various input devices, the system includes one or more image capturing devices, such as embedded camera 108 within HMD 102, external camera 109, internal cameras within HMD 102, etc., that are also connected to the HMD 102, the computer 106 and/or the server in the cloud system 112. The cameras 108 may be disposed on the outside surface of the HMD 102. The external camera 109 can be disposed on other devices, such as the computer 106, the controller 104, etc., or within the physical environment. The internal cameras (not shown in FIG. 1) are disposed on inside surfaces of the HMD 102, for example, and are used to capture facial features of the user as they are interacting with content presented on a display screen of the HMD 102. The image capturing devices are used to track and capture images of the user, images of the various input devices (e.g., wearable and user operable devices) and various objects in the physical environment in which the user is operating. The tracking is done by capturing images of visual indicators, such as lights, tracking shapes, markers, any distinguishing features in the physical environment, disposed on or associated with each of the input devices. The various user operable input devices and wearable devices can also be tracked using embedded sensors. The captured images and/or sensor data pertaining to the HMD 102, the glove interface object 103, the controller 104 (e.g., a single-handed controller operated using a single hand of a user, a two-handed controller operated using both hands of the user), the headphones 105a, earphones 105b, and/or other input devices are used to determine the location, position, orientation, and/or movements of the user 100 in the physical environment. The connections between the HMD 102, the computer 106, the network 110, the glove interface object 103, controller 104, headphones 105a, earphones 105b, camera 108, external camera 109, etc., may be wired or wireless.

The inputs provided by the various input devices can be applied to the interactive application or to perform some other function or action within a virtual world. The interactive application may be a video game application (i.e., virtual reality (VR) application), an augmented/mixed reality (AR/MR) application, or any other interactive application. The additional forms of input can include gesture inputs provided on a portion of the surface of the input device. The portion where the gesture inputs are provided, in some implementations, is an interactive input interface or interface that is devoid of any sensors for detecting the gesture inputs. For instance, in an input device with touch-screen surface for providing inputs, the gesture input can be provided on a portion of the surface that is different from the portion where the touch-screen surface is defined. The touch-screen surface includes a plurality of sensors embedded within to detect the touch input provided at different locations of the touch screen surface. In alternate implementations, the portion of the surface for providing gesture input can include the portion where a touch-screen surface is defined. In such implementations, specific type of finger (e.g., soft touch, quick swipe, etc.,) gestures provided at the touch-screen surface are distinctly detected using signature audio sounds generated by the finger gestures and the detected signature audio sounds are interpreted to define additional input. The additional input identified from the signature audio sound generated by the finger gesture is interpreted using an audible sound interpretation module, wherein the audible sound interpretation module can be included in the audio filter. The audio filter receives the sound from the one or more microphones distributes within the various input devices and/or in the physical environment and include both the ambient sounds and the sound generated by the finger gesture (e.g., signature audio sound). The audio filter filters out the ambient sounds and retains the signature audio sound using the frequency profiles of the various sounds received from the microphones and uses the audible sound interpretation module to process the signature audio sound to determine the input. In some implementations, the audible sound interpretation module is defined by the components of the audio filter. The additional input identified using the signature audio sounds is different from the touch input detected using sensor data of the touch-screen surface.

In some implementations, the input device for providing the gesture input and for interpreting the gesture input to define an input for an interactive application can, in fact, be two input devices. In these implementations, the first input device can include the interactive input interface/surface where the finger gesture is provided by the user. The microphone and the audio filter used to process the signature audio sound generated by the finger gesture is provided on a second input device. For instance, the first input device can be a controller, a headphone, an carphone, or a touchpad on which the finger gesture is provided and the second input device can be a HMD or a computer or the server. In another instance, the interactive input interface/surface and the microphone can be part of a first device and the audio filter can be on the second device. In both cases, the first input device is communicatively coupled to the second input device so as to receive the sounds captured by the microphone and to identify and process the signature audio sound of the finger gesture.

The gesture inputs provided on the surface of the input device (either on the touch-screen surface of a touch screen device or non-touch-screen surface of the touch screen device or other input device) can be swipe gestures or tap gestures, for example. These gesture inputs are detected using signature audio sounds generated by the respective gesture inputs. The signature audio sounds are interpreted to identify an input. For example, the interpreted gesture input can be used to identify and activate a functional button defined on an input device (e.g., controller) or to activate a function in an interactive application executing on the computer 106 or on a server in the cloud system 112. In some implementations, the interpreted gesture input can be used to define additional input functions for applying to the interactive application, in addition to the input functions associated with input buttons or controls of a controller. For example, due to the limited number of input buttons or controls available at the controller 104, only a finite number of functions can be defined. If the user wants to define additional functions, the user can use the additional forms of input to define the additional functions.

In some implementations, the gesture inputs are provided on a portion of the surface of the input device where a physical pattern is defined. The physical pattern can include indentations or detectable uneven texture or pattern defined on the surface of the input device. The indentations/patterns cause a signature audio sound to be generated when a user runs their fingers over the physical patterns. In some implementations, the physical pattern with noticeable uneven surface is a logo or an icon or a marker defined on the surface of the input device. In other implementations, the physical pattern is defined using a physical sticker with distinctive pattern or uneven surface/texture defined thereon. The signature audio sounds generated by the gesture inputs provided on the surface of the input device with a physical pattern or a physical sticker are detected, in some implementations, using one or more microphones that are available within the input device where the gesture inputs are provided. In alternate implementations, the signature audio sounds generated from the gesture input of the user are picked up by the microphone(s) disposed on one or more of other input devices (i.e., wearable and/or user operable input devices) along with other sounds originating within the physical environment where the user is operating. Where more than one microphone is disposed in an input device, the microphone can be part of a microphone array. The microphones can be disposed on an outside surface or on an inside surface or embedded within the respective one or more input devices. Alternately, some of the microphones can be disposed on the outside surface and the remaining ones of the microphones can be disposed on the inside surface or embedded within. The signature audio sound of the gesture input is processed to identify or define an input function that can be applied in an interactive application, for example. The use of signature audio sound of the finger gestures on the surface of the input device to define or identify additional functions for an interactive application provide a low-cost alternative that can be realized using the existing designs of the input devices and does not require of redesigning the input devices.

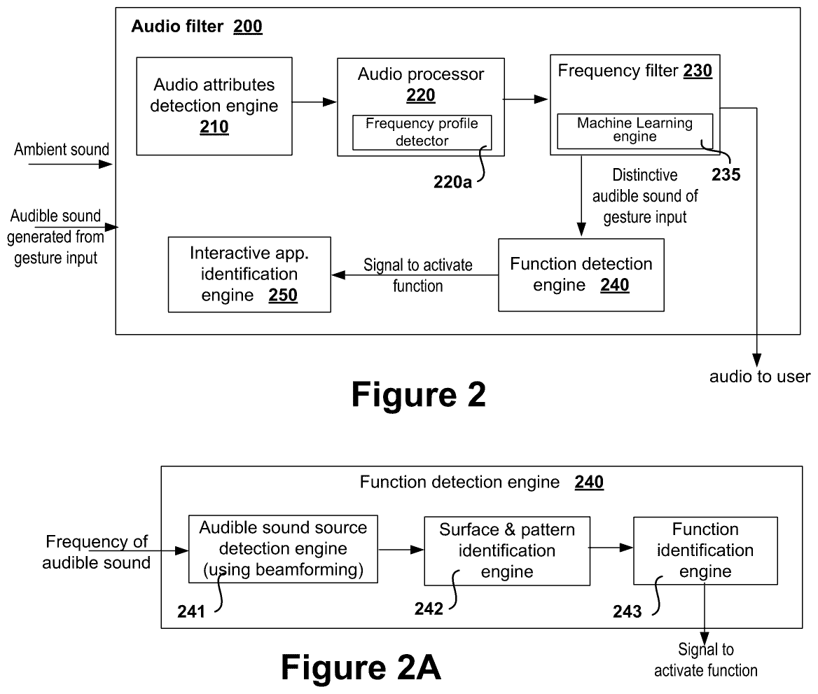

FIG. 2 illustrates various components of an audio filter module 200 used to process the various sounds captured from the physical environment of a user, in some implementation. The various sounds include ambient sound and specific sound generated for gesture input provided by a user. The gesture input can be a finger of a user running over a surface of an input device and the signature audio sound generated by such gesture input is sufficiently audible for a microphone to detect and capture. Depending on the surface characteristics of the surface on which the gesture input is provided, the signature audio sound emitted for the gesture input can differ in frequency profile and volume and the microphone is tuned to detect and capture the sound of such gesture inputs, in addition to capturing the ambient sound generated in the physical environment where the microphone is disposed. In cases where a microphone array is used, the sound emitted by each source (e.g., the gesture input, other object or entity in the physical environment) is picked up by each of the microphones in the array and is used to pinpoint the location from where the sound originated. The audio sound captured by the microphone/microphone array including the ambient sound and the signature audio sounds of the finger gestures are processed by the audio filter module 200.

The audio filter module 200 is configured to provide quality audio input to the user by identifying and processing the different sounds detected by the microphone(s), including the different signature audio sounds generated by the finger gesture on different input surface. The audio filter module 200 uses the attributes of the different sounds to reliably identify the source for the different sounds and, depending on the purpose for which the sounds are being processed, to determine which ones of the sounds to provide to the user and which ones to filter out. For example, the user may activate a noise-cancellation function of an input device, such as the headphone or earphone, in which case the ambient sound detected by the microphone(s) are identified and filtered out. In another example, the user may be seeking alternate or additional forms of input. In such cases, the signature audio sounds generated by the finger gesture (i.e., gesture input of the user) can be used to provide such input by selectively processing the finger gesture input. The finger gesture input can be associated with a function of an interactive application or a function button on the input device (e.g., controller, headphone, etc.) and processing the signature audio sounds can include activating the function or function button, in response to detecting the finger gesture on the input surface.

As noted, depending on the type of surface on which the finger gesture is provided, the frequencies and other attributes of the signature audio sound can vary. For example, the input device can include a pattern defined in a portion of a surface, wherein the pattern may be part of an icon, a logo or a self-design and include uneven surfaces due to the presence of a textured design, dots, indentations, or other noticeable features. In some implementations, the portion where the pattern is defined may be identified to be an area that is suited to receive the finger gesture. The area can be identified to be proximal to where microphone(s) are integrated into the input device so that the microphone(s) can capture the essence of the finger gestures, such as fast swipe, slow swipe, speed, hard touch, soft touch, slide, etc. When the finger of the user is run over the portion of the surface with the pattern, the signature audio sound generated for the finger gesture is distinctly different from the signature audio sound generated when the finger is run over a portion of the surface without the pattern, although the finger run over the textured and non-textured surfaces generate some signature audio sound. Similarly, the sound generated when the finger is run over a surface with a pattern having a defined depth (i.e., textured finish with defined unevenness) is much more pronounced and distinctly different (with specific frequency profile) from the sound generated when the finger is run over a surface with a pattern that has a narrower depth. The signature audio sound generated by the finger gestures on the various surfaces may not have high fidelity but can nevertheless be detected and captured by the tuned microphone(s) based on the distinct frequency profile.

The distinctly different signature audio sounds generated by the finger gesture on different surfaces (i.e., surfaces with different finish—smooth surface, surface with pattern 1 defined thereon, surface with pattern 2 defined thereon, etc.,) are processed by the audio filter module 200 in a similar manner as the processing of the ambient sound. The audio filter module 200 includes a plurality of components to assist in detecting the different sounds included in the audio sound provided by the microphone(s) and to distinctly identify each sound, including the different signature audio sounds generated by finger gestures on different surfaces of the input device. Some of the components of the audio filter module 200 used in detecting the signature audio sound of the finger gestures and identifying the appropriate functions for the finger gestures include an audio attributes detection engine 210, an audio processor module 220, a frequency filter engine 230, a function detection engine 240 and an interactive application identification engine 250.

The audio filter module 200 engages the audio attributes detection engine 210 to analyze cach sound received via the microphone(s) to identify the relevant attributes. When more than one microphone is used to capture each sound, the attributes associated with each sound captured by each microphone can be different, which can be attributed to the distance, location and orientation of the microphone from the sound source and the audio attributes detection engine 210 captures the differences in the attributes for each sound. The attributes of the sound captured by each microphone can be used to identify details such as sound source identifier, location of sound source in the physical environment, direction of sound, wavelength, amplitude, frequency, velocity, duration, etc. When the sound is the signature audio sound of the finger gestures (i.e., gesture input provided using fingers of a user), the attributes of the finger gestures identified by the audio attributes detection engine 210 include, finger gesture source identifier, the location of the source of the finger gesture on the input device, direction of the finger gesture, surface characteristics of the surface at the identified location, etc., in addition to the wavelength, amplitude, frequency, velocity, duration of the signature audio sound. The attributes of the finger gestures are used to determine the frequency profile of the signature audio sound. The attributes of the finger gestures (including the frequency profile) along with the attributes of the ambient sounds are forwarded to an audio processor module 220.

The audio processor module 220 engages a frequency profile detector engine 220a to identify the frequency profiles of the various sounds included in the audio sound provided by the audio attributes detection engine 210. As each sound is associated with discretely different set of attributes, the audio processor module 220 is able to determine the discrete frequency profile of each sound from the different set of attributes. For example, the finger gesture can be a swipe gesture on a surface of the input device that has a pattern defined thereon. The attributes of the swipe gesture can include swipe speed, swipe direction, distance covered, swipe gesture time lapse, swipe amplitude (both maximum and minimum), etc. Since the sounds generated for the finger gestures vary with variance in the surface characteristics of the surface, the attributes of the sounds captured at the respective surfaces reflect such variances and the frequency profile determined from the attributes reflect these variances. The surface characteristics details pertaining to the signature audio sound include identity of a portion of the surface of the input device where the finger gesture was provided, type of surface (smooth or textured/patterned, patterned surface or physical sticker) in the portion, type of pattern defined, orientation of the pattern, identity of the physical sticker when the pattern is defined using a physical sticker disposed in the location, function associated with the pattern, etc. The portion of the surface where the finger gesture is detected can be any surface on the input device, including, without limitations, a surface without any noticeable textures, a surface with a noticeable pattern (i.e., with pronounced indentations, defined uneven profile, touch surface with or without uneven profile) and the surface characteristics of the portion are identified accordingly. The surface characteristics of the portion of the input device where the finger gesture is received can be determined by analyzing images captured by the image capturing devices (e.g., 108, 109, etc.). The attributes of the signature audio sound generated from the finger gesture thus include details of the signature audio sound as well as the details of the different surface characteristics of the surface associated with the finger gesture and the frequency profile determined from the attributes capture the finer details of the signature audio sound and are associated with the finger gesture on the respective surfaces.

In some implementations, the pattern can be defined to include vertically oriented or horizontally oriented indentations or patterns, wherein the patterns can be defined to include a level of grading (e.g., amount of indentation). In some implementations, the pattern can be provided by a logo or self-design defined on the surface, wherein the pattern can be defined by surface unevenness due to inclusion of dots, ridges/indentations, etc., in the logo, image or other self-design. In some other implementations, the pattern can be defined using self-adhering physical stickers that have a pattern defined thereon. In some implementations, the pattern on the physical sticker is defined using a micro-mesh, wherein the pattern can include vertically oriented or horizontally oriented pattern defined with dots, indentations, ridges and/or other noticeable uneven patterns, etc. In some implementations, the physical sticker defined using the micro-mesh is associated with a function button of a controller 104, for example, on which the physical sticker is disposed. In other implementations, the physical sticker can be disposed on the surface of the HMD 102, or on a surface of the glove interface object 103, or on the surface of the headphone 105a or earphone 105b. Alternately, the physical sticker can be disposed on a touchpad. The touchpad provides a larger surface area to receive interaction and is configured to couple with the HMD 102, and/or the computer 106, and/or the server on the cloud system 112 over the network 110. In some implementations, the pattern defined by the micro-mesh of the physical sticker is hard-coded into the function button so that every time the finger gesture is detected on the physical sticker, the function button is automatically activated. In other implementations, the details of the micro-mesh and/or the physical sticker identifier is included in the software program used to define the function associated with the function button. In some implementations, the indentations or ridges or uneven patterns are considered when such patterns are of at least of specific depth, as the depth in the pattern results in generating distinctly different signature audio sound. In other implementations, the uneven patterns are considered even when the patterns are not of the specific depth as the finger gesture over such uneven pattern will still generate a signature audio sound. In addition to the depth feature, the orientations of the patterns defined on the surface or on the physical sticker or direction of the finger gestures on the patterns can result in the generation of distinctly different signature audio sounds. For example, if the physical sticker includes a particular pattern extending horizontally, then the finger gesture on the pattern can generate at least two distinctly different signature audio sounds depending on the direction of the finger gesture-a first signature audio sound when the finger is run along the horizontal direction of the pattern, and a second signature audio sound when the finger is run along the vertical direction of the same pattern. The two distinctly different signature audio sounds can correspond to two different functions-a first function that corresponds with the first signature audio sound and a second function that corresponds with the second signature audio sound. In some implementations, more than one physical sticker can be provided on the surface of the input device. In such implementations, each of the physical sticker can be function-specific. In some implementations, cach physical sticker can correspond to a function button (i.e., control button or control surface) on a controller. Thus, depending on the type of surface (e.g., plain (i.e., un-patterned), patterned, type and orientation of pattern) defined in a portion of the surface of the input device and the direction of the movement of fingers over the portion, different signature audio sounds are generated, with each signature audio sound being associated with a distinct function or distinct function button of the input device (e.g., controller). The attribute details of the various sounds (i.e., the ambient sounds and the signature audio sounds generated by finger gestures) identified by the audio processor module 220 are provided as input to the frequency filter engine 230.

The frequency filter engine 230 uses a machine learning engine 235 to create and train an artificial intelligence (AI) model, and to use the inference of the trained AI model to verify the identity of the finger gesture input provided by the user using the frequencies and other attributes identified for the signature audio sound generated by the finger gesture. The machine learning engine 235 trains the AI model using as inputs the attributes of the different finger gestures provided by a plurality of users at a portion of the surface of the input device and the corresponding signature audio sounds generated from such finger gestures. The portion of the surface of the input device can have different surface characteristics and the AI model is trained to identify the different surfaces using the attributes of the finger gestures of the plurality of users on such surfaces and the corresponding signature audio sound generated from the finger gestures. In some implementations, when more than one microphone is used to capture the signature audio sound of the finger gesture, certain ones of the attributes, such as the location of the finger gesture, direction of the finger gesture, etc., are determined using a concept called “beamforming”, wherein the different attributes are determined based on the amplitudes and when the sound waves generated by the finger gesture are received at each microphone. Using the times when the sound waves of the finger gestures are received at the respective microphones, time differential of when each microphone in a pair of microphones received the sound wave of the sound generated by the finger gesture, is determined. The time differentials from the different pairs of microphones in the microphone array are used to pinpoint the location of the source of the finger gesture and to determine which microphone is closer to the location from where the sound waves of the signature audio sound originated. The location of the signature audio sound, in some implementations, is defined as a function of time the acoustic wave signal of the signature audio sound is received at each microphone in the microphone array, distance of each microphone of the microphone array from the corresponding physical sticker or pattern that caused the signature audio sound to be generated, and location of each microphone in relation to other microphones in the microphone array.

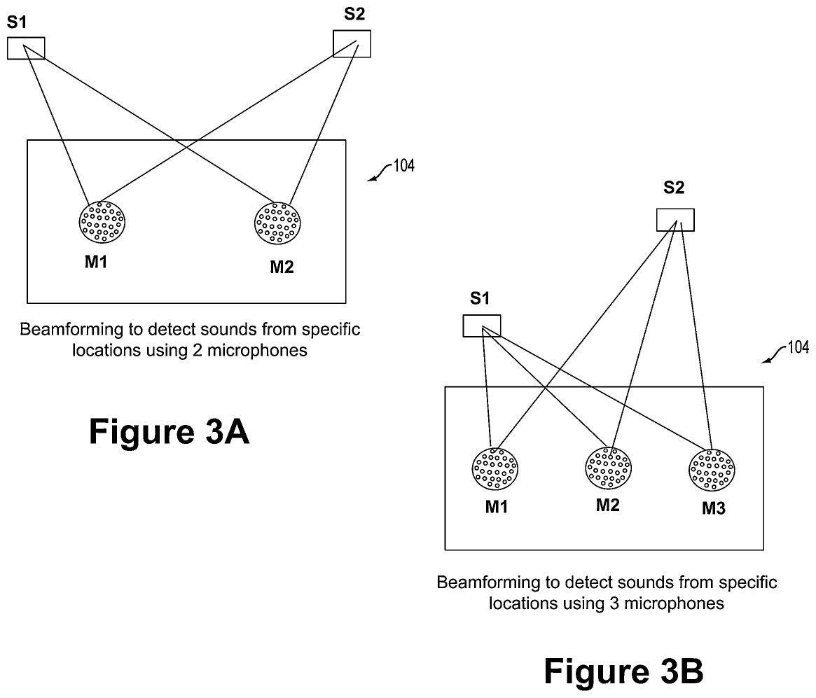

FIGS. 3A and 3B illustrate some examples of using beamforming to pinpoint origination location of the sound waves associated with the signature audio sound generated by the finger gesture on a portion of the input device, in some implementations. FIG. 3A illustrates using the beamforming concept with two microphones disposed in a portion of an input device, such as a controller 104, and FIG. 3B illustrates using the beamforming concept using three microphones in the portion of the input device (e.g., 104). As shown in FIG. 3A, a finger gesture generated at source ‘S1’ is detected by the microphones M1, M2 disposed in the portion of the input device, such as the controller 104. The microphones M1, M2, for example, can be disposed on the outside surface or the inside surface or embedded within the portion of the controller 104 and configured to detect the sound in the vicinity of the controller 104 operated by the user. The location and orientation of the microphones M1, M2 are provided as examples and other locations and/or orientations can also be envisioned. The difference in the time when the sound wave of the finger gesture is received at microphone M1 and microphone M2 is used to determine the distance between source S1 and each of the microphones M1, M2. The relative distances of the microphones M1, M2 suggest that source S1 is closer to microphone M1 than to microphone M2. Similarly, for the finger gesture generated at source ‘S2’, it is determined that source ‘S2’ is closer to microphone M2 than to microphone M1. In some implementations, the sound source (i.e., surface where the finger gesture is provided) may be located in the middle of the microphones M1, M2, and the beamforming can identify the location of the sound source to be equidistant from the microphones M1 and M2.

FIG. 3B illustrates an example where 3 microphones M1, M2 and M3 are disposed at the input device (e.g., controller) and used to detect the relative distance of the source of sound from each microphone, from which the location of the source of the sound can be easily deduced. As can be seen, the microphones M1, M2, M3 are equidistantly disposed in a portion of the input device and receive the signature audio sound generated from the finger gesture of the user at the portion of the input device. Using the time differential of when each of the microphones M1, M2 and M3 receive the signature audio sound from each of the sources S1, S2, it can be determined that the source S1 is closer to microphone M1, a little farther away from microphone M2 and farthest away from microphone M3. Similarly, it can be determined that the source S2 is closer to microphone M3, a little farther away from microphone M2 and farthest away from microphone M1.

Referring back to FIG. 2, the gesture input of the user is reliably detected from the finger gestures of the user and the source of the input is identified. The attributes and other details related to the various sounds, including the finger gestures, are used by the frequency filter engine 230 to determine how to process the audio sound for user consumption. For instance, depending on the purpose for which the audio sounds are being used, the frequency filter engine 230 filters out certain ones or all of the audio sound received at the audio filter 200. For example, when the input device is a noise-cancelling headphone, the audio filter 200 is used to filter out sounds of all detected frequencies so as to prevent any sound from reaching the user's ears. In some cases, when a noise-cancellation function is activated at the input device, the signature audio sounds of the finger gestures are retained by the frequency filter engine 230, so that the signature audio sounds resulting from the user's finger gestures can be used to identify and activate a specific function at an interactive application. The noise-cancellation function may be activated by the user during gameplay of a video game to filter out the ambient sound generated in the physical environment, so that the user can focus on the sounds of the video game and react appropriately. In this case, the audio filter 200 ensures that the user is not provided any ambient sound while continuing to retain and process the signature audio sound of the finger gesture to identify a function associated with the finger gestures for applying to the video game. The finger gestures provide additional form of input to the video game. In another example, if the user is interacting with other users in an interactive application, such as a video game, via the HMD 102, the audio filter 200 can be used to filter out select ones of the sound from certain ones of the sources (e.g., sound from non-video-game related sources, or audio generated by users of an opposing team, or audio generated by spectators, etc.) and retain the sound generated by certain other ones of the sources (e.g., audio of the video game or audio generated by users who are in the same team as the user or audio generated by game objects that are in the game scene where the user is interacting, etc.). The frequency filter module 230 thus is configured to perform the filtering of the ambient and signature audio sounds in accordance to the purpose for which the input device is being used and such filtering is done in real-time as the user is interacting with the video game application. Any retained ambient sound is provided to the HMD 102 for user consumption and the signature audio sound of the finger gesture is forwarded to the function detection engine 240 to identify and activate the corresponding function.

As noted, some of the audio is retained and provided to the user for user consumption. The audio that is retained for user consumption, in some implementations, is ambient sound. In addition to the retained sound, the signature audio sound from the finger gesture (i.e., gesture input) on the input surface is forwarded to the function detection engine 240. The function detection engine 240 uses the location related attributes of the signature audio sound to identify a function associated with it.

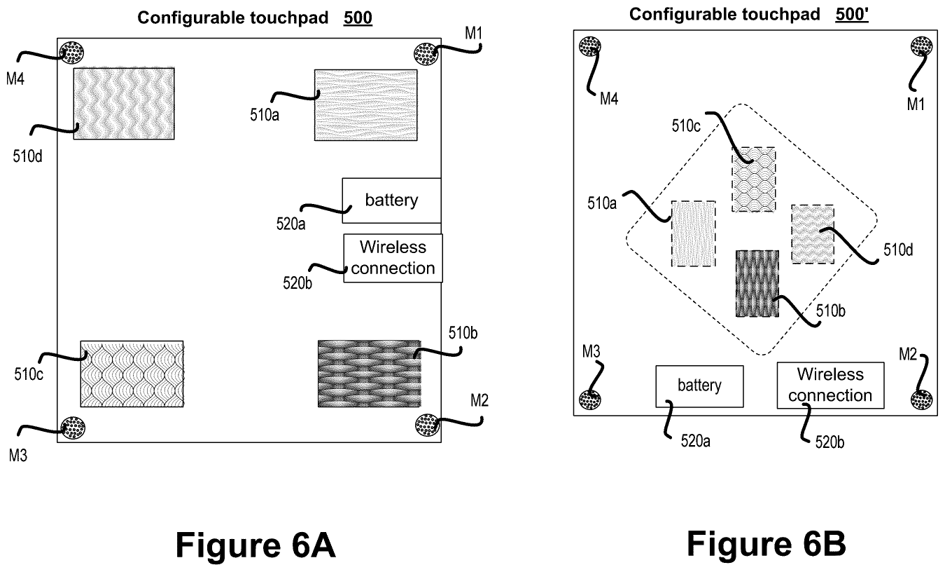

FIG. 2A illustrates some of the components of the function detection engine 240 that can be used to identify the function for the signature audio sound, in some implementations. Some of the components include an audible sound source detection engine 241, surface and pattern identification engine 242 and function identification engine 243. The frequency of the signature audio sound is used as input to the audible sound source detection engine 241. The audible sound source detection engine 241 can use the data determined using the beamforming concept discussed with reference to FIGS. 3A and 3B, for example, to pinpoint a location of the source of the signature audio sound and the type of surface in the location where the finger gesture was provided. The source of the signature audio sound can be identified as the location where a pattern is defined on the surface of an input device, such as HMD 102, glove interface object 103, controller 104, headphone 105a, carphone 105b, or touchpad (500 shown in FIGS. 6A & 6B), on which the finger gestures are received. As noted earlier, the pattern can be a self-design, such as a logo or icon or any other design, with strong indentations, or can be a removable physical sticker with patterns, and the location of the portion can be an area on the input device that is conducive to receive the finger gestures. The source and location of the source of the signature audio sound are used by a surface and pattern identification engine 242 to determine the type of pattern defined at the location. The pattern identification engine 242 can use the data from the audible sound source detection engine 241 and, in some cases, images from the image capturing devices to identify the location and the type of pattern defined at the location. Since the type, the texture, and the orientation of the pattern on the surface can influence the signature audio sound generated by the finger gesture on the pattern, identifying the surface and the type of pattern is useful to define and identify the function associated with the pattern. The surface and pattern identification engine 242 examines the surface characteristics of the surface in the location of the source of signature audio sound to determine if any pattern is defined at the location, the type of pattern defined, orientation, pattern characteristics, such as indentations, dots, vertical grading, horizontal grading, etc.

The identified surface and pattern characteristics of the pattern identified by the surface and pattern identification engine 242 are used by the function identification engine 243 to identify a specific function that is associated with the pattern and/or the surface characteristics of the portion where the finger gesture is received. As noted, some patterns can have micro-mesh and a function button on an input device, such as a controller or keyboard, can be hard-coded with the pattern of the micro-mesh, so that the finger gestures on the micro-mesh can responsively detect interaction at the micro-mesh, and identify and activate the function associated with the function button defined for the pattern of the micro-mesh. Upon detecting the function for the signature audio sound generated by the finger gesture, a signal is generated and transmitted to an interactive application to activate the function. In some implementations where physical stickers are used to define the pattern, the patterns can be custom designed to generate distinct sounds and the distinct sounds can be used to define different functions, so that when a particular sound is generated by the finger gesture, the function detection engine 240 can automatically identify and activate the corresponding function associated with the sound.

Upon identifying the function to apply to an interactive application, the function detection engine 240 communicates to the interactive application identification engine 250 the identifier of the function, the identifier of the interactive application where the function is to be applied, and a signal with instructions to activate the function at the interactive application. The interactive application identification engine 250, in response to receiving the instructions from the function detection engine 240, activates the appropriate function at the interactive application.

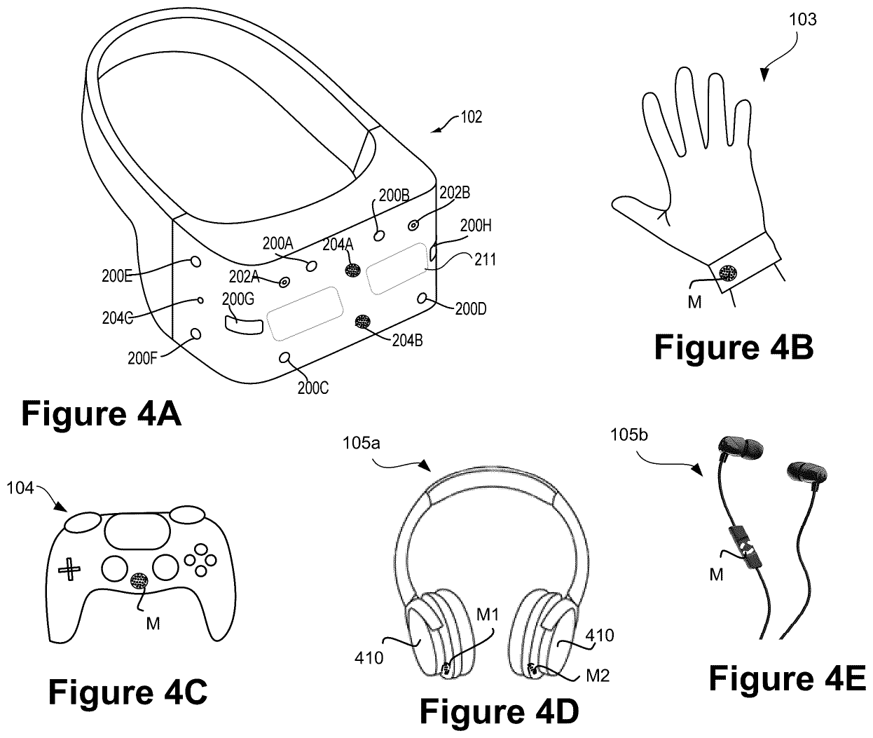

FIGS. 4A-4E illustrate some of the input devices on which a finger gesture provided on a portion of a surface can be detected, so that the attributes of the finger gesture can be identified and used to define or identify a function for applying to an interactive application, in some implementations. FIG. 4A illustrates an HMD 102 (an example input device) that can be used to provide the finger gestures on a surface, such as the side strap surface, of the HMD 102. The finger gestures can include a swipe gesture, a tap, a slide, a soft touch, etc. The HMD 102 is equipped with microphone(s) that is/are tuned to detect the signature audio sound of the finger gestures in addition to detecting the ambient sound occurring in the physical environment in which the user wearing the HMD 102 is present. Microphones 204A and 204B are defined on the front surface of the HMD 102, and microphone 204C is defined on a side surface of the HMD 102. Of course, the location of the microphones 204A-204C are provided as mere examples and additional microphones can be located in other locations. By utilizing an array of microphones, sound from each of the microphones can be processed to pinpoint the location of the sound's source. This information can be utilized in various ways, including exclusion of unwanted sound sources, association of a sound source with a visual identification (e.g., pattern, physical sticker with pattern, etc.), etc. The signature audio sound produced by the finger gestures detected by the microphones 204A-204C are processed to define an input for applying to an interactive application.

The HMD 102 also includes image capturing devices 202A and 202B (108 of FIG. 1) (e.g., stereoscopic pair of image-capturing devices) disposed on the outside surface on the front face of the HMD 102. By using multiple stereoscopic image-capturing devices, it is possible to capture three-dimensional images and video of the physical environment from the perspective of the HMD 102. The HMD 102 can be configured to allow a user to have a fully immersive experience (i.e., virtual reality experience) by including a non-transparent display screen. Alternately, the display screen of the HMD 102 can be transparent allowing the user to view the physical environment of the real-world in the vicinity of the user. In this case, images of virtual elements or objects or super-imposed over portions of the real-world objects, allowing the HMD 102 to be configured for augmented reality applications. The HMD 102 also includes a pair of lens 211 that is part of the optics, with each lens of the pair being oriented in front of each eye of the user, when the user wears the HMD 102. The pair of lens 211 may be configured to adjust the image of virtual objects and view of real-world objects in accordance to vision characteristics of the user. Lights 200A-200H are disposed on outside surface of a frame of the HMD 102 and can be used as visual indicators to track the six degrees of freedom position (6DOF pose) of the HMD 102, in some implementations. In alternate implementations, the image capturing devices 202A and 202B (108 of FIG. 1) can be used to track the 6DOF pose of the HMD 102. Tracking the 6DOF pose of the HMD 102 is not restricted to the aforementioned ways and other ways of tracking the 6DOF pose of the HMD 102 can also be envisioned.

FIG. 4B illustrates a glove interface object 103 that can be worn on a hand of a user and used to provide gesture input. The gesture input provided using the glove interface object 103 is detected and captured by the microphone ‘M’ disposed on the glove interface object 103. The microphone M can be a single microphone or part of a microphone array. In alternate implementations, the microphone can be located on a different device, such as the HMD 102 or a controller 104 communicatively connected to the glove interface object 103 and used to detect the signature audio sound of the gesture input.

FIG. 4C illustrates a controller 104 that is used to provide control inputs to an interactive application. A portion of a surface of the controller 104 (e.g., a portion on one or both handles or any other surface) can be used to provide the gesture input. The microphone ‘M’ disposed on the controller 104 is tuned to detect and capture the gesture input provided on the surface of the controller 104. In some implementations, the gesture input can be provided on the touch input surface defined on the controller and the microphone M is able to detect the gesture input. The gesture input is interpreted to define a function for applying to an interactive application.

FIG. 4D illustrates a headphone 105a that can be worn by the user over their head and on top of their cars. In some implementations, the headphone 105a can be a noise-cancelling headphone, wherein the user can activate the noise-cancellation function of the headphone so as to prevent all the ambient sound from reaching the cars of the user. The headphone 105a includes microphones ‘M1’, ‘M2’ to detect and capture the signature audio sound generated by the finger gestures provided by the user on the surface of the headphone 105a (e.g., the touch surface 410, surface of the headband, etc.). The signature audio sound identified for the finger gestures are interpreted to identify and activate a corresponding function at an interactive application.

FIG. 4E illustrates an carphone 105b with earbuds that can be inserted directly into the car canals of the user. As with the headphone 105a, the user may be able to provide finger gesture on a surface that is proximal to where the microphone ‘M’ is disposed and the microphone M detects and captures the finger gesture. The captured finger gestures generate signature audio sound that can be interpreted to activate a function at an interactive application. The HMD 102, the glove interface object 103, the controller 104, the headphone 105a, carphone 105b, are all input devices that can be used as-is to provide finger gestures that generate low volume signature audio sound that can be detected and captured by microphones disposed at each of the input devices and processed to define an input (e.g., activation of a function) to an interactive application.

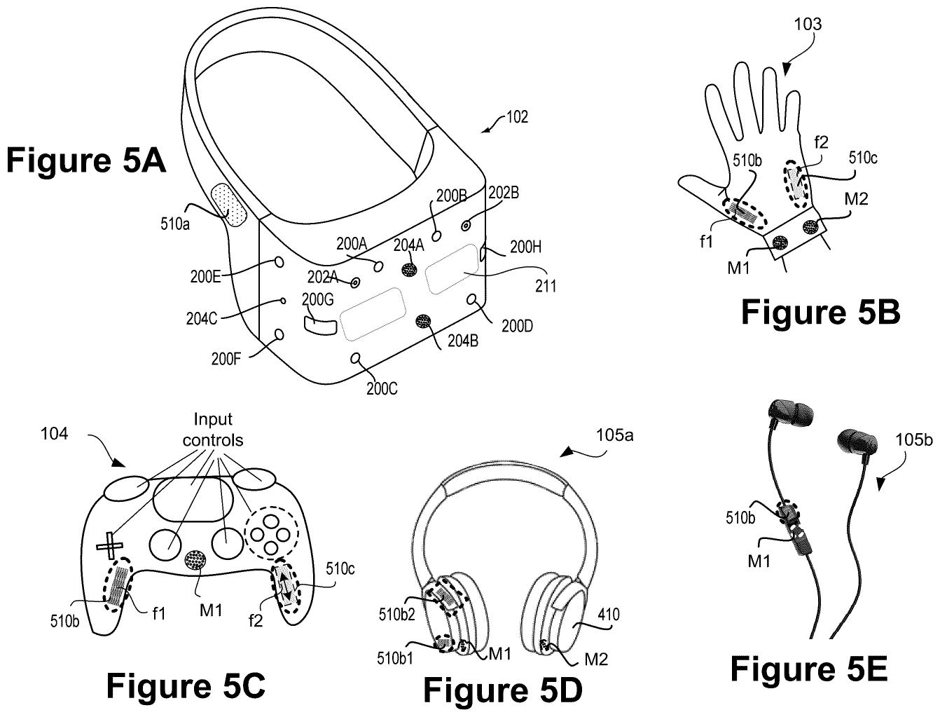

FIGS. 5A-5E illustrate the input devices of FIGS. 4A-4E with the exception that cach of the input devices in FIGS. 5A-5E have a detectable pattern defined in a portion of the surface of the respective input devices on which the finger gestures of the user can be received. Consequently, the parts of each input device that are common are represented using same reference numerals. The finger gestures received on the pattern generate signature audio sounds that are detected and captured by the microphones disposed on the respective input devices. FIG. 5A shows the HMD 102 with a distinguishing pattern 510a defined on a portion of a side strap of the HMD 102. The pattern 510a is defined by dots that have strong indentations so that when the user runs their finger over the surface, the pattern causes a signature audio sound that can be distinctly detected and captured by the microphones 204A, 204B and 204C. The pattern 510a is from a design that is defined directly on the surface of the portion of the side strap or is a physical sticker that is adhered to the surface. The physical sticker is a removable sticker. Different patterns can be defined directly on the surface or by using different physical stickers. The different patterns defined with dots, ridges or indentations running horizontally or vertically or diagonally can generate different signature audio sounds, wherein cach signature audio sound can be used to define a distinct input. In addition to the location and orientation of the pattern, the direction of movement of the finger when providing the finger gesture can also generate different signature audio sounds. Thus, a single pattern defined on the input device can generate more than one signature audio sound and hence be associated with more than one function/function button depending on the direction of the pattern, orientation of the pattern, and direction of movement of the finger over the pattern.

FIG. 5B illustrates the glove interface object 103 with a pair of patterns 510b, 510c defined on different portions of the surface. More than one pattern can be defined on the input device, wherein the patterns can be designs defined directly on the surface and/or with the use of physical stickers. The patterns 510b, 510c have distinctly different patterns that are different from the pattern 510a defined on the HMD 102. The patterns 510b, 510c have a certain depth that causes the signature audio sounds generated by the finger gesture on the respective patterns (510b, 510c) has distinct frequency profiles. The signature audio sound generated by the finger gesture on pattern 510b has a frequency profile ‘f1’ and the signature audio sound generated by the finger gesture on pattern 510c has a frequency profile ‘f2’. Additionally, the glove interface object 103 of FIG. 5B is shown to include two microphones, M1 and M2, unlike the glove interface object 103 shown in FIG. 4B which is shown to include only one microphone M1. The number of microphones, the type of patterns, the location of the patterns are all configurable to ensure that the signature audio sound generated from such patterns are distinct. In some implementations, the patterns defined on the glove interface object 103 can have same pattern (e.g., 510b or 510c or even 510a or any other pattern). In such implementations, the signature audio sound generated at each pattern can still have different attributes due to the location, and/or direction, and/or orientation of the pattern. Consequently, the same pattern can be disposed on different portions of the surface of the input device and used to define different functions/function buttons.

FIG. 5C illustrates a controller 104 having a plurality of controls (input buttons, sticks, touchpad, etc.) used to provide control inputs. Each control is used to define a function at an interactive application. The controller 104, in one implementation, is shown to be a dual-handle controller and includes a first pattern 510b defined in a portion of a surface of the left handle and a second pattern 510c defined in a portion of a surface of the right handle. In another implementation, a single-handle controller can be contemplated, in which case, a first pattern 510b and a second pattern 510c can be defined on different portions of the controller. Each of the two patterns defined on the controller 104 generates signature audio sounds with distinct frequency profiles, with the first pattern 510b generating a first signature audio sound with frequency profile ‘f1’ and the second pattern 510c generating a second signature audio sound with frequency profile ‘f2’. The microphone ‘M1’ detects and captures the first and the second signature audio sounds when the finger gesture is provided on the respective surfaces of the patterns 510b, 510c. The signature audio sounds are interpreted to identify an input, wherein the input can be function or a function button on the controller 104.

FIG. 5D illustrates the headphone 105a having a pattern defined on a surface of the headphone 105a. For example, the pattern 510b1 can be disposed on the touch surface that is used to control some of the functions of the headphone or the pattern 510b2 can be on a side surface of the carcups. The microphones can be defined proximal to the pattern in a different portion of the side surface of the carcups. In the example implementation shown in FIG. 5D, the headphone 105a includes two microphones M1 and M2, although fewer or more microphones can also be envisioned. The microphones M1 and M2 detect and capture the signature audio sounds generated at the respective patterns 510b1 or 510b2. The captured signature audio sounds are interpreted to define an input to an interactive application.

FIG. 5E illustrates a variation of the carphone 105b illustrated in FIG. 4E. The variation in the carphone 105 is due to the presence of a pattern 510b on a surface proximal to where the microphone M1 is disposed on the carphone. The pattern 510b generates a signature audio sound that can be detected and captured by the microphone and processed to define an input for applying in an interactive application. It is noted that the pattern, such as an icon or a logo or a self-design, can be directly defined on the surface or can be defined on a physical sticker that is adhered to the respective surfaces. Further, the pattern having similar design in FIGS. 5A-5E is represented using same reference numeral even when the pattern is defined or disposed on different input devices. In the case where physical stickers are used, the physical sticker is replaceable or reusable. For example, the input device could be a controller on which a first physical sticker is disposed. The first physical sticker is associated with a first function that can be activated by a finger gesture on the surface of the physical sticker. In some implementations, the first physical sticker can be replaced with a second physical sticker that is associated with a second function. The replacement of the physical sticker can be performed when a second function needs to be activated by the finger gesture. In other implementations, instead of replacing the first physical sticker with a second physical sticker at the same physical location, the second physical sticker may be provided on a different portion of the input device so that finger gesture on the second physical sticker can activate a second function. The first and the second physical stickers, in some implementations, are programmed to generate signature audio sounds that correspond to distinct functions (i.e., first function and second function respectively). In this case, both the first physical sticker and the second physical sticker are made available to provide two different functions. Further, the strength of the audio sound captured by the microphone(s) can be dependent on the amount of distance separating the pattern and the microphone(s). Using a microphone array with plurality of microphones can ensure that the signature audio sound of the finger gesture is detected accurately. Further, the orientation of the pattern can also be changed to allow defining additional inputs, as the direction of the pattern, the orientation of the pattern and direction of the finger gesture on the pattern can all influence the signature audio sound generated for the finger gesture.

FIGS. 4A-4E illustrate examples of input devices devoid of any pattern on the respective surfaces on which finger gestures are received from the user and interpreted to identify an input for applying to an interactive application. FIGS. 5A-5E illustrate examples of input devices on whose surfaces one or more patterns are defined (e.g., self-design or physical stickers with pattern) to receive finger gestures. The finger gestures provided by the user on such patterned surfaces are detected and interpreted to identify an input for applying to an interactive application. In some other implementations, a touchpad can be defined to include one or more patterns over which finger gestures can be provided to define inputs to an interactive application.

FIGS. 6A-6B illustrate some examples of a touchpad 500 that can be used as an input device to provide the finger gestures. The touchpad 500 provides a large surface interface for providing the input. The surface of the touchpad 500 or portions of the surface of the touchpad can be a rough surface with a strong texture (i.e., texture with certain depths) or include one or more patterns defined in portions thereon, or include one or more physical stickers having patterns thereon. The physical stickers are removable, reconfigurable and reusable. In some implementations, the touchpad can be rectangular or square in shape and a pattern can be defined in each corner, or on opposite corners, or on the center of each side, or lined up along one side, or lined up in the middle, or arranged in the center, etc. The shape of the touchpad is not restricted to rectangle or square shape but can include other shapes. Each physical sticker is defined to include strong indentations (e.g., ridges) or dots of at least defined depth, etc., to define a strong pattern. In some implementations, each physical sticker being programmed or designed to generate a specific signature audio sound, wherein the signature audio sound corresponds to a particular function.

FIG. 6A illustrates one example touchpad on which 4 patterns (510a-510d) are defined with a pattern defined in each corner. In the implementation illustrated in FIG. 6A, cach of the patterns is defined using a physical sticker, although different patterns defined directly on the surface of the touchpad can also be envisioned. The touchpad also includes a microphone array with cach microphone M1-M4 in the array being disposed in each corner proximal to each pattern. The touchpad includes a power source 520a, such as a battery, to power up the microphone array and any other circuitry defined on the touchpad, and a wireless connection 520b (e.g., Bluetooth connection) to couple the touchpad 500 with other devices, such as the computer 106, the HMD 102, the controller 104, etc. The battery can be a low-power battery with sufficient power to charge the circuitry and microphone array. The wireless connection enables the touchpad to communicate data between the touchpad 500 and the other connected devices. In some implementations, the touchpad 500 can be configured to be a controller with each pattern on the controller associated with a distinct function or function button that correlates with a corresponding function button of a traditional controller. The number of patterns, the orientation of the patterns, the type of function to associate with each pattern can be customized by or for the user (i.e., user-specific). In alternate implementations, the type of function/function button to associate with each pattern can be customized for each interactive application. For example, a sticker book with distinct set of physical stickers can be used to define different functions, wherein cach distinct physical sticker in the sticker book is used to generate a signature audio sound that can be used to define a particular function, thus making the physical stickers to act as controls of the touchpad 500. As and when an additional function is needed, additional physical sticker can be provided on the touchpad 500 with the additional physical sticker programmed for activating the additional function. As noted, more or less patterns can be defined on the touchpad 500 and the patterns can be placed anywhere and in any orientation on the touchpad 500.

FIG. 6B illustrates an alternate placement of the patterns 510a-510d on the touchpad 500 than what was shown in FIG. 6A, wherein the patterns can be defined on the surface or can be defined by physical stickers. To keep the illustrations simple, the number of patterns and the pattern style shown in FIG. 6B are same as what is shown in FIG. 6A. However, the location and orientation of the patterns 510a-510d as well as the location of the battery 520a and wireless connection 520b are shown to be different in FIG. 6B. In FIG. 6B, the patterns are oriented vertically as opposed to horizontal orientation in FIG. 6A, and are disposed in the center instead of the corners of the touchpad 500. The number and location of the microphones M1-M4 in FIG. 6B remain the same as in FIG. 6A. The number, the pattern style, the orientation, location of patterns can vary. In some cases, the same pattern style can be disposed in different locations and, as a result, be associated with different functions.

The various embodiments and implementations describe a low-cost way of providing additional forms of input without having to re-design the input devices (i.e., the input devices can be used as-is). In alternate implementations, the input devices can be modified to include patterns or patterned physical stickers to define different surfaces and use the finger gestures on the patterns to provide additional inputs (i.e., additional functions) or additional ways of activating existing functions. In yet other implementations, a new controller (i.e., input device) can be designed using a touchpad and physical stickers or patterns defined on the touchpad. The touchpad is a configurable input device that can be effectively used to detect different types of inputs using different textured stickers/patterns and defining a distinct function for each type of input, making it a low-cost yet versatile and customizable input device for providing the inputs to an interactive application.

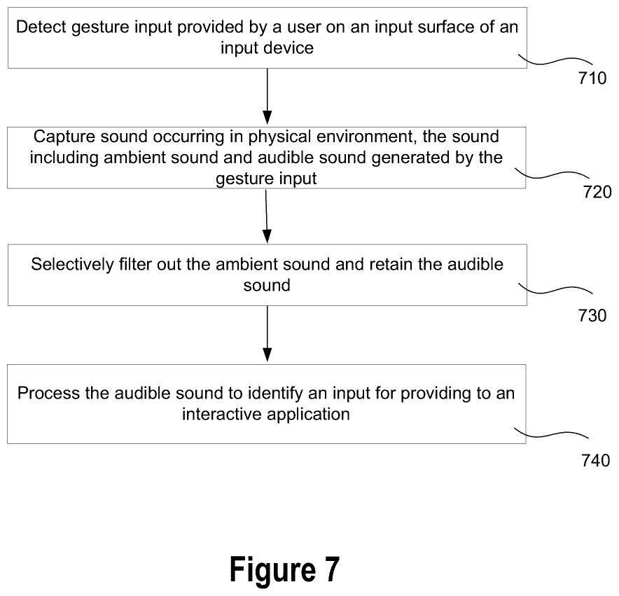

FIG. 7 illustrates operations of a method for detecting gesture input on an input device, in some implementations. The method begins at operation 710 when a gesture input provided by a user on an input surface of the input device is detected. The gesture input can be a finger gesture, such as a swipe, a tape, a soft touch, etc., and is provided on a surface of the input device. The gesture input generates a signature audio sound. Sound occurring in a physical environment in which the user is operating is captured using one or more microphones integrated within the input device, as illustrated in operation 720. The sound occurring in the physical environment includes ambient sound and the signature audio sound of the finger gesture. The ambient sound is selectively filtered out from the captured sound and only the signature audio sound is retained, as illustrated in operation 730. An audio filter may be used to detect the different types of sound captured by the one or more microphones and using the frequency of the different sounds, selectively filter out the sounds with frequency profiles that do not match the frequency profile of the signature audio sound. The signature audio sound is then processed to identify an input that is forwarded to an interactive application to activate a function, as illustrated in operation 740. The signature audio sound generated by the finger gesture is a low-volume and low fidelity sound that can be used to provide additional form of input to an interactive application.

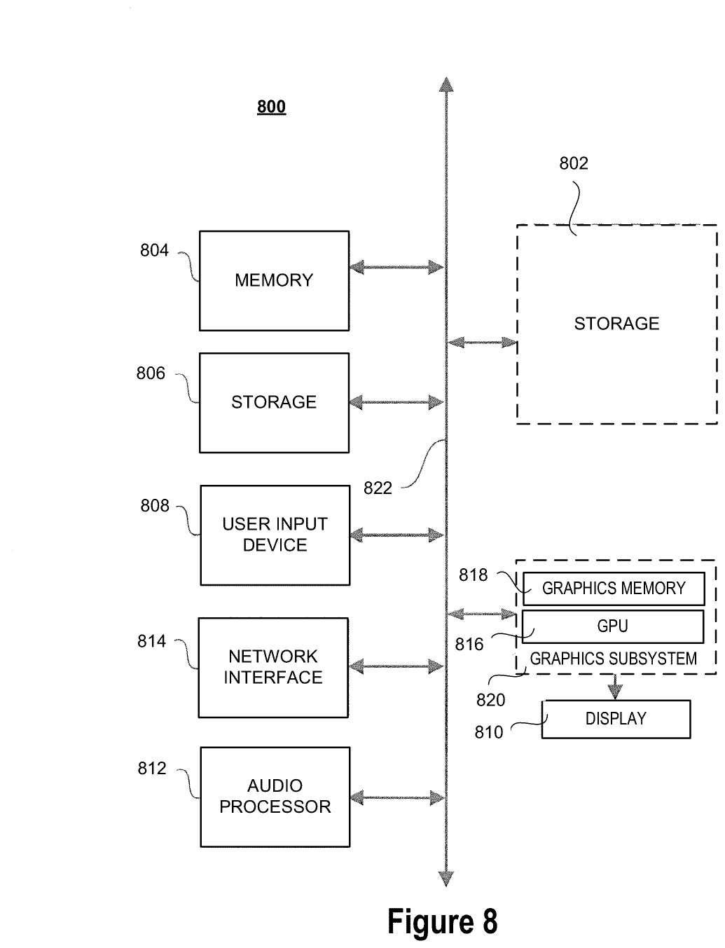

FIG. 8 illustrates components of an example device 800 that can be used to perform aspects of the various embodiments of the present disclosure. This block diagram illustrates a device 800 that can incorporate or can be a personal computer, video game console, personal digital assistant, a server or other digital device, suitable for practicing an embodiment of the disclosure. Device 800 includes a central processing unit (CPU) 802 for running software applications and optionally an operating system. CPU 802 may be comprised of one or more homogeneous or heterogeneous processing cores. For example, CPU 802 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 800 may be localized to a player playing a game segment (e.g., game console), or remote from the player (e.g., back-end server processor), or one of many servers using virtualization in a game cloud system for remote streaming of gameplay to clients.

Memory 804 stores applications and data for use by the CPU 802. Storage 806 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 808 communicate user inputs from one or more users to device 800, examples of which may include keyboards, mice, joysticks, touch pads, touch screens, still or video recorders/cameras, tracking devices for recognizing gestures, and/or microphones. Network interface 814 allows device 800 to communicate with other computer systems via an electronic communications network, and may include wired or wireless communication over local area networks and wide area networks such as the internet. An audio processor 812 is adapted to generate analog or digital audio output from instructions and/or data provided by the CPU 802, memory 804, and/or storage 806. The components of device 800, including CPU 802, memory 804, data storage 806, user input devices 808, network interface 810, and audio processor 812 are connected via one or more data buses 822.

A graphics subsystem 820 is further connected with data bus 822 and the components of the device 800. The graphics subsystem 820 includes a graphics processing unit (GPU) 816 and graphics memory 818. Graphics memory 818 includes a display memory (e.g., a frame buffer) used for storing pixel data for each pixel of an output image. Graphics memory 818 can be integrated in the same device as GPU 808, connected as a separate device with GPU 816, and/or implemented within memory 804. Pixel data can be provided to graphics memory 818 directly from the CPU 802. Alternatively, CPU 802 provides the GPU 816 with data and/or instructions defining the desired output images, from which the GPU 816 generates the pixel data of one or more output images. The data and/or instructions defining the desired output images can be stored in memory 804 and/or graphics memory 818. In one embodiment, the GPU 816 includes 3D rendering capabilities for generating pixel data for output images from instructions and data defining the geometry, lighting, shading, texturing, motion, and/or camera parameters for a scene. The GPU 816 can further include one or more programmable execution units capable of executing shader programs.

The graphics subsystem 814 periodically outputs pixel data for an image from graphics memory 818 to be displayed on display device 810. Display device 810 can be any device capable of displaying visual information in response to a signal from the device 800, including CRT, LCD, plasma, and OLED displays. Device 800 can provide the display device 810 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (Saas). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experience. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, cach of which may reside on different server units of a data center.

According to this embodiment, the respective processing entities for performing the operations may be a server unit, a virtual machine, or a container, depending on the needs of cach game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as HTML, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. An input device, comprising:
an interactive input interface for receiving a gesture input from a user, the gesture input generating a signature audio sound;
a microphone to capture audio occurring in vicinity of the input device including the signature audio sound provided by the gesture input from the user, wherein the signature audio sound of the gesture input is defined to be of a frequency profile; and
an audio filter configured to detect different frequencies of audio captured from the vicinity of the input device and to selectively detect and retain the signature audio sound of the gesture input and filter out audio with frequencies that do not match the frequency profile, the signature audio sound of the frequency profile is interpreted to identify an input for providing to an interactive application.

2. The input device of claim 1, the interactive input interface is defined on a portion of a surface of the input device, and the microphone is configured to detect and differentiate the signature audio sound of the gesture input of the user from other audio captured in the vicinity.

3. The input device of claim 2, wherein the portion of the surface is defined to be proximal to the microphone.

4. The input device of claim 1, wherein the input device is a headphone, or a noise cancelling headphone, or a head mounted display, or a controller, or an earphone, or a touchpad.

5. The input device of claim 1, wherein the microphone is a microphone array with two or more microphones, and
wherein the two or more microphones of the microphone array are disposed on an inside surface, or an outside surface, or embedded within, or select ones of the two or more microphones of the microphone array are disposed on the inside surface and select other ones of the two or more microphones of the microphone array are disposed on the outside surface of the input device.

6. The input device of claim 1, wherein the input device is a combination of a first input device and a second input device that are communicatively coupled to one another,
wherein the interactive input interface is disposed on a first surface defined on the first input device, and the microphone and the audio filter are disposed within the second input device, and
wherein the microphone is a microphone array with two or more microphones.

7. The input device of claim 6, wherein the first input device is a controller or an earphone or a headphone or a touchpad, and wherein the second input device is a head mounted display or a computing device coupled to the first input device.

8. The input device of claim 1, wherein the interactive input interface is defined to include a physical pattern having indentations, depth of the indentations defined to create the signature audio sound when a finger of the user is run over the physical pattern.

9. The input device of claim 8, wherein the physical pattern is defined on a self-adhering sticker that can be adhered to a surface defined in a portion of the input device, the physical pattern defining an uneven surface for causing the signature audio sound, and
wherein the self-adhering sticker is replaceable.

10. The input device of claim 1, wherein the signature audio sound is interpreted to identify the gesture input using an audible sound interpretation module executing at the input device, the signature audio sound corresponds to a distinct function.

11. An input device, comprising:
a physical sticker disposed on a surface of the input device, the physical sticker including a micro-mesh to provide a signature audio sound when a finger of a user is run over the micro-mesh;
a microphone to capture audio generated in vicinity of the input device including the signature audio sound provided at the surface of the physical sticker, wherein the signature audio sound of the input is defined to have a frequency profile; and
an audio filter configured to detect different frequency profiles of audio captured from the vicinity of the input device and to selectively detect and retain the signature audio sound of the input with the frequency profile by filtering out audio with frequency profiles that do not match the frequency profile, the signature audio sound with the frequency profile is interpreted to identify a gesture input provided at the micro-mesh of the physical sticker, the gesture input interpreted to identify an additional input to an interactive application.

12. The input device of claim 11, wherein the physical sticker is replaceable, and
wherein the micro-mesh has a distinct design to cause the signature audio sound, the signature audio sound is used to define a distinct function.

13. The input device of claim 11, further includes a second physical sticker disposed in a second portion on the surface of the input device that is different from a portion where the physical sticker is disposed, the second physical sticker defined by a second micro-mesh having a second distinct design to cause a second signature audio sound when the finger of the user is run over the second micro-mesh, and
wherein the second signature audio sound has a distinct second frequency profile that is different from the frequency profile of the physical sticker and the frequency profile of other sounds in the audio.

14. The input device of claim 13, wherein the second physical sticker is replaceable and is used to define a second distinct function.

15. The input device of claim 13, wherein the microphone is a microphone array with two or more microphones, the two or more microphones use beamforming to detect and distinctly identify the signature audio sound or the second signature audio sound, so as to activate a distinct function corresponding to the physical sticker or the second distinct function corresponding to the second physical sticker.

16. The input device of claim 11, wherein when the input device is a noise-cancellation device and a noise-cancellation function is activated, the audio filter of the input device is designed to retain the signature audio sound of the audio and to filter out other sound in the audio with frequency profile that does not match the frequency profile of the signature audio sound and to interpret the signature audio sound of the input to identify a function and to generate a signal to activate the function within the interactive application.

17. An input device, comprising:
a touchpad providing an input surface for receiving input from a user,
one or more physical stickers for placement on the input surface of the touchpad, each physical sticker having a micro-mesh defining a pattern that is designed to provide a signature audio sound when a finger of the user is run over surface of said each physical sticker;
a microphone array disposed on the touchpad, the microphone array including a plurality of microphones configured to detect and capture audio generated in vicinity of the input device, wherein the audio includes the signature audio sound generated by the finger of the user running over the surface of said physical sticker, the signature audio sound generated at said physical sticker is interpreted to identify a distinct control of an input control device that corresponds with a distinct function of an interactive application;
a power source to supply power to the microphone array; and
a communication connection to couple the touchpad to a computing system executing the interactive application, the communication connection used to communicate a signal to activate the distinct function associated with said physical sticker at the interactive application, upon detecting the finger of the user running over the surface of said physical sticker,
wherein the communication connection is a wireless connection.

18. The input device of claim 17, wherein said each physical sticker is programmed to generate a specific signature audio sound that corresponds to a particular function of the interactive application.

19. The input device of claim 17, wherein when more than one physical sticker is placed on the input surface of the touchpad, the micro-mesh of each physical sticker is distinct, the signature audio sound generated at said each physical sticker is designed to activate a corresponding distinct function at the interactive application, and
wherein a location and an orientation of each physical sticker is configurable.

20. The input device of claim 17, wherein number, the placement, and orientation of each physical sticker is configurable to be user-specific. device-specific, function-specific, or application-specific.
